(19) United States
(12) Patent Application Publication
(10) Pub. No.: US 2025/0001349 A1
(43) Pub. Date: Jan. 2, 2025

(54) INLINE FLUID PURIFIER

(71) Applicant: Trajan Scientific Americas Inc., Pflugerville, TX (US)

(72) Inventors: Achmad N. Hidayatullah, Louisville, KY (US); Christopher A. Carlisle, Louisville, KY (US); David S. Hubbard, Louisville, KY (US); Edward J. Heiny, Houston, TX (US)

(73) Assignee: Trajan Scientific Americas Inc., Pflugerville, TX (US)

(21) Appl. No.: 18/753,219

(22) Filed: Jun. 25, 2024

Related U.S. Application Data
(60) Provisional application No. 63/510,972, filed on Jun. 29, 2023.

(51) Int. Cl. B01D 53/04; B01D 46/00; B01D 46/10; B01D 53/26

(52) U.S. Cl. CPC B01D 53/0407; B01D 46/0012; B01D 46/0036; B01D 46/10; B01D 53/261; B01D 2253/116; B01D 2253/308; B01D 2257/80

(57) ABSTRACT

An inline fluid purifier includes a body having an inline port on a first end, an angled port on an opposite second end, an interior containing molecular sieve adsorbent media having a pore diameter of less than 3.3 angstroms, and multi-piece assembly seals on each port.

### CROSS-REFERENCE TO RELATED APPLICATION

This application claims the benefit of priority to U.S. provisional patent application Ser. No. 63/510,972, filed Jun. 29, 2023, for INLINE FLUID PURIFIER, incorporated herein by reference.

### FIELD OF THE INVENTION

An inline fluid purifier includes a body having an inline port on a first end, an angled port on an opposite second end, an interior containing molecular sieve adsorbent media having a pore diameter of less than 3.3 angstroms, and multi-piece assembly seals on each port.

### BACKGROUND OF THE INVENTION

Various devices require fluid as input. In some embodiments, this fluid is a gaseous fluid. As one example, gas chromatographs typically use helium, nitrogen, argon or hydrogen gas as input. As another example, medical cryoablation devices typically use nitrous oxide gas as input. It is common for devices requiring fluid as input to include internal or external fluid purification systems to remove contaminants. Typical inline fluid purifiers include a cylindrical body with opposing ends and a central axis, an inlet port arranged parallel to the central axis on one end and an outlet port arranged parallel to the central axis on the opposite end. The interior of the body typically includes an adsorbent for collecting contaminants from fluid flowing from a fluid source, into the inlet port, through the interior, exiting through the outlet port, and continuing on to the device requiring the fluid.

Proper installation of a typical inline fluid purifier during initial assembly or replacement can be challenging, as the fluid purifier is radially symmetrical. While the inlet port and outlet port are typically labelled, a careless installation may result in the outlet port attached to the fluid source and the inlet port attached to the device requiring the fluid. A typical fluid purifier may include a relatively coarse filter in proximity to the input port, a relatively fine filter in proximity to the outlet port, with the adsorbent located between the filters. Careless installation of an inline fluid purifier in the reverse direction may result in clogging, reduction of fluid flow through the purifier and early failure of the purifier, as contaminants first encounter the fine filter instead of sequentially encountering the coarse filter, adsorbent media and fine filter. Also, there is a risk that contaminants already within the adsorbent media may pass through the coarse filter and enter the device requiring the fluid, when such contaminants may be blocked if the inline fluid purifier was properly installed with the fine filter in the downstream position.

An inline fluid purifier used intermittently typically experiences a temperature spike during the startup process as flowing fluid first enters the purifier, as a fluctuation in pressure within the fixed volume interior of the purifier results in a fluctuation in temperature. This unsteady state temperature can cause adsorbed contaminants within the fluid purifier to desorb into the outlet fluid stream. Unsteady state temperature in the fluid purifier can also delay the device receiving fluid from the purifier from reaching a steady state, thus delaying use of the device. Elevated temperatures can also cause damage to nearby components or cause burns to users contacting the purifier.

### SUMMARY

It is the object of the present invention to provide an improved inline fluid purifier unable to be installed in a reversed orientation and configured to mitigate temperature fluctuations during the startup process. The disclosed inline fluid purifier includes non-symmetrical inlet and outlet ports, such that one port is aligned inline with the central axis of the fluid purifier and the other port is arranged at a non-parallel angle to the central axis. The disclosed inline fluid purifier further includes adsorbent media, such as molecular sieves, with a pore diameter smaller than the kinetic diameter of the carrier fluid flowing therethrough to minimize temperature increases due to exothermic adsorption of fluid molecules within the adsorbent media. For example, an inline fluid purifier intended to purify a gas stream of nitrous oxide (N₂O) would include adsorbent media with a pore diameter of less than 3.3 angstroms, as available data suggests the kinetic diameter of N₂O is 3.3 angstroms.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein is not necessarily intended to address every object described herein, and each embodiment does not necessarily include each feature described. Other forms, embodiments, objects, advantages, benefits, features, and aspects of the present invention will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

A better understanding of the present invention will be had upon reference to the following description in conjunction with the accompanying drawings.

FIG. 1 depicts a top plan view of an inline fluid purifier.

FIG. 2 depicts a side view of the inline fluid purifier.

FIG. 3 depicts a second end view of the inline fluid purifier.

FIG. 4 depicts a first end view of the inline fluid purifier.

FIG. 5 depicts a cross-sectional side view of the inline fluid purifier along lines A-A of FIG. 1.

FIG. 6 depicts an enlarged view of the second end of the cross-sectional view of FIG. 5.

FIG. 7 depicts an enlarged view of the first end of the cross sectional view of FIG. 5.

FIG. 8 is a chart depicting capacity tests for 3 angstrom (“3A”) and 5 angstrom (“5A”) molecular sieve adsorbents.

FIG. 9 is a chart depicting the increase in temperature (ΔTₘₐₓ) of fluid purifiers containing molecular sieves with pore diameters of 13 angstrom (“MS13A”), 3 angstrom (“MS3A”), 4 angstrom (“MS4A”) or 5 angstrom (“MS5A”) upon initial charge with N₂O at 500 pounds per square inch at gauge pressure (“PSIG”).

FIG. 10 is a chart depicting log breakthrough volume for fluid purifiers containing MS3A or MS5A by temperature.

### DETAILED DESCRIPTION OF THE PREFERRED EMBODIMENTS

For the purposes of promoting an understanding of the principles of the invention, reference will now be made to selected embodiments illustrated in the drawings and specific language will be used to describe the same. It will nevertheless be understood that no limitation of the scope of the invention is thereby intended; any alterations and further modifications of the described or illustrated embodiments, and any further applications of the principles of the invention as illustrated herein are contemplated as would normally occur to one skilled in the art to which the invention relates. At least one embodiment of the invention is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to “advantages” provided by some embodiments of the present invention, other embodiments may not include those same advantages, or may include different advantages. Any advantages described herein are not to be construed as limiting to any of the claims.

Specific quantities (spatial dimensions, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated. Unless otherwise indicated, the word “about” indicates a range of values within ten percent of the most precise significant digit of the number prefaced by the word (e.g., “about 1” is the range of 0.9 to 1.1; “about 1.0” is the range of 0.99 to 1.01; “about 90 degrees” or “about perpendicular” is the range from 81 degrees to 99 degrees). The term “elongated” when used in connection with a cylindrical body having a central axis, refers to a body with a length parallel to the axis greater than the diameter of the body.

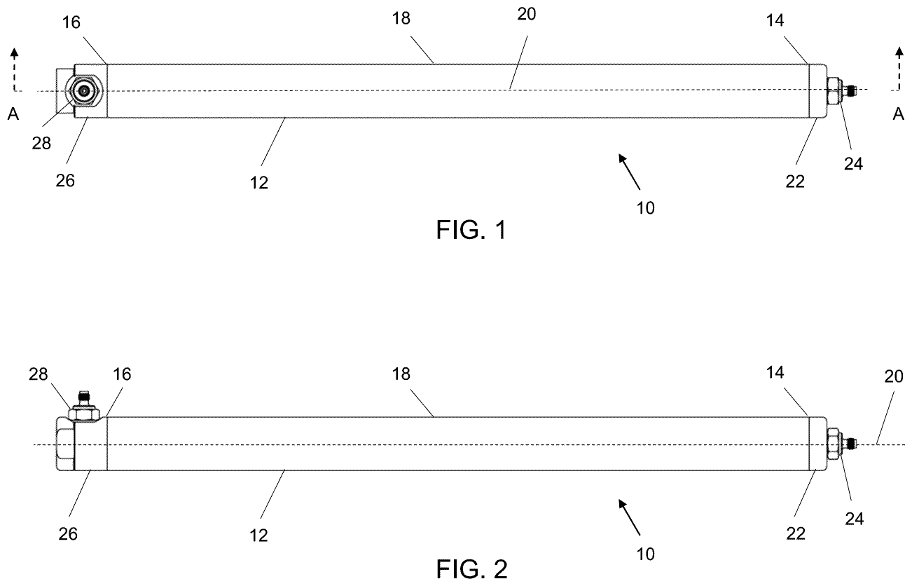

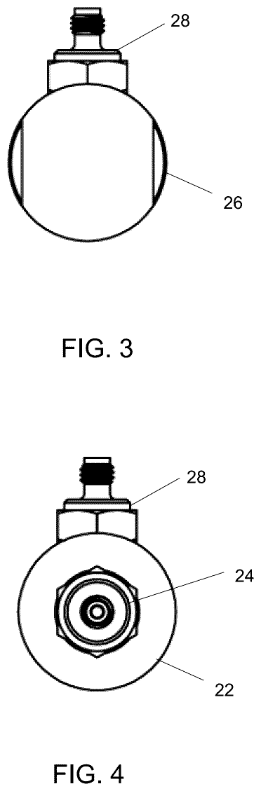

Referring now to FIGS. 1-7, an inline fluid purifier 10 includes an elongated cylindrical body 12 with an first end 14 and a second end 16 opposing the first end 14, at least one side 18 extending between the ends 14, 16, and a central axis 20. A first endcap 22 is attached to the first end 14 and includes an inline port 24 arranged parallel to the central axis 20. A second endcap 26 is attached to the second end 16 and includes an angled port 28 arranged at a non-parallel angle to the central axis 20. In the depicted embodiment, the angled port 28 is arranged about perpendicular or perpendicular to the central axis 20. In certain embodiments, the inline port 24 functions as an outlet and the angled port 28 functions as an inlet, such that fluid flow enters angled port 28, passes through the cylindrical body 12, and exits via inline port 24. In other embodiments, the roles of the ports are reversed. The varied orientations of the inline port 24 and angled port 28 creates a failsafe for proper installation of the purifier during initial assembly or replacement. Note that while the inline fluid purifier 10 is shown as having an elongated cylindrical body 12, in other embodiments, the body may be square, rectangular, oval, hexagonal, or other geometric shape in cross-section.

The cylindrical body 12 includes an interior 30 defined by the at least one side 18, the first endcap 22 and the second endcap 26. Adsorbent media 32 is provided within the interior 30. The first endcap 22 includes a first filter 34 positioned between the inline port 24 and the adsorbent media 32. The second endcap 26 includes a second filter 36 positioned between the angled port 28 and the adsorbent media 32. In some embodiments, the filters 34, 36 are fritted filters, which may be disc-shaped and made of glass, metal (e.g., stainless steel, nickel, titanium, Hastelloy, etc.) or plastic (e.g., polytetrafluoroethylene (PTFE), polypropylene, polyether ether ketone (PEEK), etc.), which both filter contaminants and retain the adsorbent media 32 within the interior 30. In certain embodiments, the pore diameter of the second filter 34 is greater than the pore diameter of the first filter 36 such that, when flowing from inlet to outlet, the fluid flow encounters the second filter 34 with relatively larger pores prior to encountering the first filter with relatively smaller pores. In a specific embodiment, the first filter 34 has a pore diameter of 1 micron and the second filter 36 has a pore diameter of 10 microns. In other embodiments, each filter may have a pore diameter ranging from 0.003 microns to 50 microns, with the second filter having a greater pore diameter than the first filter.

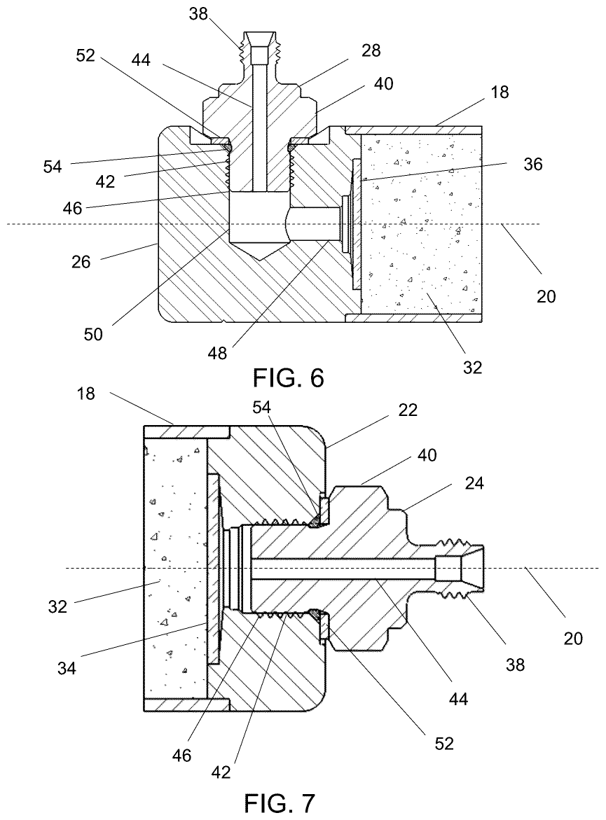

Each port 24, 28 includes a generally cylindrical threaded top portion 38, a central portion 40, and a generally cylindrical threaded bottom portion 42, wherein the diameter of the central portion 40 is larger than the diameters of the top portion 38 or bottom portion 42. Each port 24, 28 further includes an internal passageway 44 extending between the top portion 38 and the bottom portion 42. When installed, the threaded top portion 38 connects to a fluid transfer line, such as, for example, a fluid transfer line (not shown) providing nitrous oxide connected to the top portion of the angled port 28 and a fluid transfer input line of a device receiving nitrous oxide (not shown) connected to the top portion 38 of the inline port 24. The threaded bottom portion 42 of each port 24, 28 is received in a corresponding threaded cavity 46 in the respective endcap. As most easily seen in FIGS. 6 and 7, the inline port 24 engages the first endcap 22 and the angled port 28 engages the second endcap 26 via threaded engagements. The endcaps 22, 26 may engage the cylindrical body 12 via welding, friction fit, threaded engagement, adhesives, or other means for attachment as known in the art. While the ports 24, 28 shown herein attach to endcaps 22, 26 and fluid transfer lines (not shown) via threaded connections, other embodiments may use snap fit connections, friction fits, or other types of mechanical connections as known in the art.

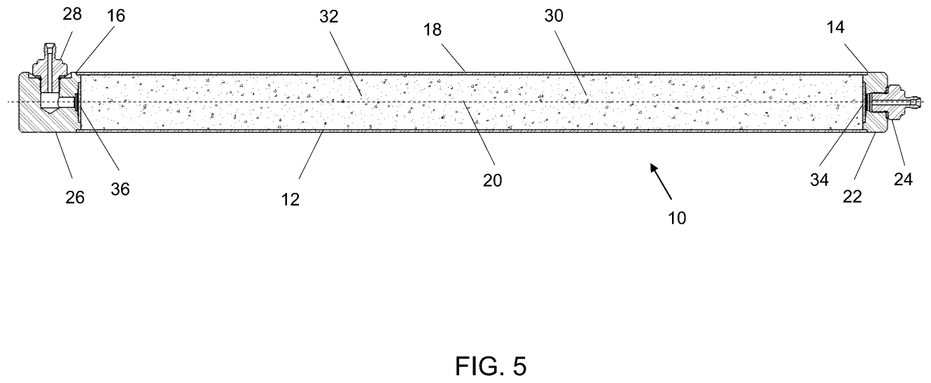

In use, fluid flow enters the disclosed inline fluid purifier 10 via the internal passageway 44 of the angled port 28, which is arranged at a non-parallel angle to the central axis 20, into an internal chamber 50 in the second endcap 26, then through an internal channel 48 in the second endcap 26 arranged parallel to the central axis 20, through the second filter 36, into the interior 30 of the cylindrical body 12 contacting the adsorbent media 32 therein, through the first filter 34, and exiting the internal passageway 44 of the inline port 24, which is arranged parallel to the central axis 20. In the embodiment shown in FIGS. 5 and 6, the internal passageway 44 of the angled port 28 is arranged substantially perpendicular or perpendicular to the central axis 20. The fluid flow through the inline fluid purifier 10 is, in some embodiments, a gaseous fluid flow and, in further embodiments, nitrous oxide.

As most easily seen in FIGS. 6 and 7, each port 24, 28 includes a multi-piece assembly seal including a metal crush seal 52 and an elastomeric seal 54. The metal crush seal 52 radially surrounds the bottom portion 42 and abuts the central portion 40. The elastomeric seal 54, such as an O-ring, radially surrounds the bottom portion 42 and abuts the metal crush seal 52. The elastomeric seal 54 fits within the endcap cavity 46 while the larger diameter metal crush seal 52 fits between the respective endcap 22, 26 and the central portion 40 of the respective port 24, 28. Use of two different sealing members of two different materials provides redundancy in sealing between the port 24, 28 and the endcap 22, 26, reducing the risk of fluid leaks. In other embodiments, metal crush seal 52 may be formed of plastics or elastomeric materials.

In preferred embodiments, all components of the disclosed inline fluid purifier in contact with the nitrous oxide stream are constructed of inert materials to avoid corrosion.

The inline fluid purifier 10 includes adsorbent media 32 in the interior 30 of the cylindrical body 12. In some embodiments, the adsorbent media 32 are molecular sieves, namely, materials with small pores of substantially uniform size. Microporous molecular sieves are typically zeolites, porous glass, active carbon, or clays, and pore diameter is typically measured in angstroms. In preferred embodiments, the adsorbent media 32 are molecular sieves with pore diameters of less 3.3 angstroms, less than 3.2 angstroms, not more than 3 angstroms, less than 3.3 angstroms and greater than 2.6 angstroms, between 3.2 angstroms and 2.7 angstroms, between 3.2 angstroms and 2.8 angstroms, between 3.1 angstroms and 2.9 angstroms, about 3 angstroms, about 3.0 angstroms, or 3 angstroms. A molecular sieve with a pore diameter of less than 3.3 angstroms inhibits N₂O molecules from entering the porous matrix, as the N₂O molecule is too large to enter the pore, while still allowing water molecules (H₂O) enter the porous matrix and be adsorbed thereon, as H₂O can enter a pore of greater than 2.6 angstroms.

Molecular sieves 3A and 5A were compared in side-by-side tests for water removal from nitrous oxide at atmospheric pressure, to help decide between them for use as a drying agent for N₂O purifiers. Parameters compared are heating on initial charge, volume of gas needed to elute water at different temperatures, and capacity under one set of worst-case but foreseeable use conditions.

Data published by molecular sieve manufacturers indicates that MS5A has higher capacity for water than MS3A over measured ranges of concentration and temperature. Adsorption data are typically determined under static conditions by exposing dry adsorbent to gas of known water content at a given temperature until equilibrium saturation is achieved. However these values cannot simply be converted to determine the active lifetime of a purifier as purifier life is a function of contamination concentration and carrier gas flow rate. The inventors are not aware of any published data determining water capacity of gas purifiers when used with nitrous oxide as the carrier gas. In order to gather a comparative set of capacities under dynamic flow conditions in nitrous oxide with low ppm water, the inventors ran a test of MS3A and MS5A in parallel, under worst-case use conditions to allow conservative predictions of actual purifier lifetimes. The measurement can also be used to compare with published static adsorption data to whether they can reasonably be used to predict other conditions not tested.

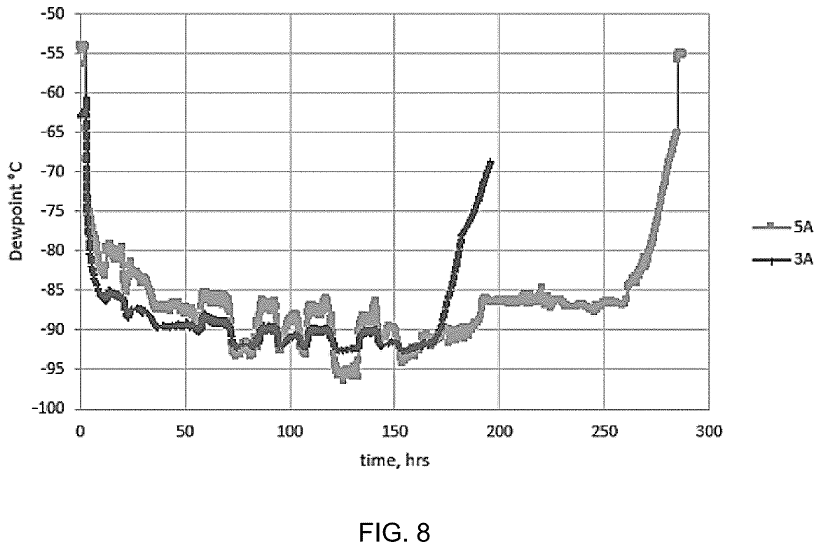

FIG. 8 depicts the results of a capacity test with 1.7 cubic centimeter (cc or cm3)/1.0 g samples of adsorbents run in parallel with 3A and 5A adsorbents. Water concentration is estimated at 40 ppmv, with flow of about 200 standard cm3/min. The test results confirmed that water at ppm concentrations displaces N₂O from N₂O-saturated molecular sieve, as expected. The test results further confirm that under the same conditions 5A has higher moisture capacity than 3A, as indicated by the respective breakthrough times. These results were predicted from published data derived under static conditions with unknown bulk gas, as it is generally known that moisture capacity of molecular sieves increases with pore diameter, but confirmed here under dynamic conditions with N₂O. A fluid purifier is typically not intended to be pressure cycled (i.e., pressured up during startup and pressured down during shutdown) at a regular frequency during the active life of the purifier, thus the problematic temperature and pressure fluctuations experienced during startup and shutdown are outweighed by the increased moisture capacity of adsorbent media with pore diameters of ≥5 angstroms and the decreased specificity of contaminants which can be adsorbed by larger pore diameter molecular sieves.

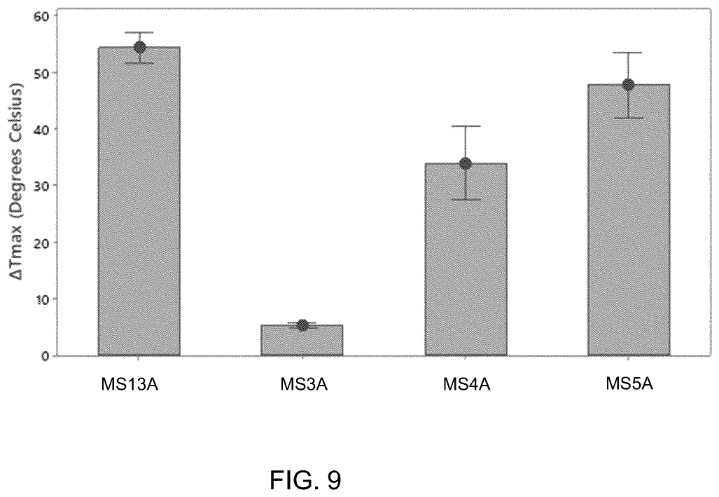

While 5A adsorbent is generally deemed preferable to 3A due to its greater moisture capacity, the inventors determined two unexpected advantages to using 3A adsorbent to remove water specifically from nitrous oxide. Referring now to FIG. 9, fluid purifiers each containing 475 cc of adsorbent media were filled in air with MS3A, MS4A, MS5A or MS13A. The temperature rise caused by heat of adsorption during initial charge with nitrous oxide at 200 psi was measured at three locations along the body of each purifier. Displacement of air was allowed by a pre-set 1 standard L/min vent to atmosphere. In the fluid purifier loaded with MS5A media, the maximum temperature increased as a function of increasing distance from the inlet port. The same phenomena likely occurred in the fluid purifier loaded with MS3A media, but the differences in temperature along the body of the purifier were too slight to confirm.

FIG. 9 depicts a comparison of the maximum temperature increase reached at the midpoint along the filter bodies due to the heat of adsorption for molecular sieves with pore sizes of 3, 4, 5 and 13 angstroms, respectively. As shown by FIG. 9, no significant heating occurred during the initial charge of the purifier containing MS3A, whereas the temperature increases of the larger pore sizes (MS4A, MS5A and MS13A) demonstrate that N₂O fills the larger pores with a corresponding exothermic release of energy. These results incidentally confirm that N₂O is excluded from the 3A pore volume since the pore walls account for most of the surface area.

Maximum heating with 5A reached 70° C. Temperatures were highest at the outlet end. The apparent “notches” in the 5A measurements between the 5 minute and 10 minute marks are from momentarily raising the hood sash to access the thermocouples to reposition instruments for datalogging, as the greater flow with the open hood sash slightly cooled the purifier. In actual use, a purifier's temperature might rise higher than 70° C. if charged with N₂O at 750 psi rather than 200 psi, but this additional heat increase may be due to adiabatic compression rather than additional adsorption. Inhibiting nitrous oxide absorption by using the 3A molecular sieve minimizes temperature increase due to the heat of absorption of nitrous oxide and adiabatic pressurization, thus mitigating significant temperature fluctuations experienced while the purifier is in use with 5A or larger molecular sieve adsorbent media.

“Breakthrough volume” is the amount of gas needed to drive water through the adsorbent, typically expressed as number of adsorbent bed volumes. Breakthough volume depends on temperature, concentration of water in the incoming gas, and characteristics of the adsorbent which include strength of surface attraction, pore diameter and surface area. Breakthrough volume is practically independent of flow rate until it exceeds the rate of diffusion into the adsorbent media, such that the gas does not enter the adsorbent media-commonly referred to as “blow by.”

When breakthrough volume is determined at the limit of a very small or trace plug of gaseous water eluted with an otherwise dry gas, it indicates the rate of migration through the particular adsorbent at the given temperature. Molecular sieves are extremely efficient at retaining water, with breakthrough volumes in the tens of millions at room temperature. It is this strong affinity that allows assignment of meaningful capacity to what is an equilibrium process, without chemical reaction. Since the breakthrough volumes are so large they are usually determined at elevated temperature and extrapolated to lower use temperatures. Values are calculated simply from the flow rate and time to elute water.

Breakthrough volume can also refer to the amount of gas that can be purified by a filter under given conditions of use. This could be directly measured but would take an enormous amount of time in real-life conditions. When known, the breakthrough volume is easily converted to maximum time of use.

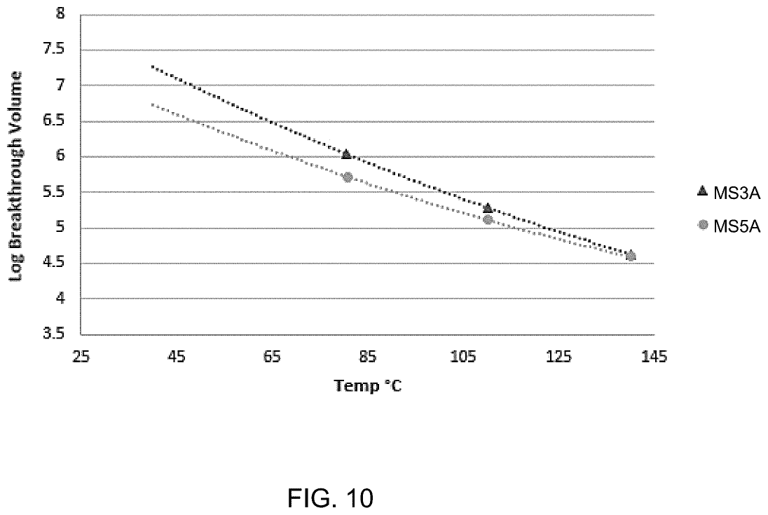

Breakthrough volumes as an indication of migration rates were determined under nitrous oxide flow with 1.1 cc samples of 3A and 5A molecular sieves at elevated temperatures. Results at use temperatures are predicted by extrapolation to 40° C. as the worst case, or lower. As shown in FIG. 10 and Table 1, 3A provides a slower migration rate than 5A, though it generally has lower capacity at given inlet water concentrations.

TABLE 1
Measured and Extrapolated Breakthrough Volumes
for MS3A and MS5A by Temperature

| MS3A | | | MS5A | | |
|---|---|---|---|---|---|
| Temp | Breakthrough | Log Breakthrough | Temp | Breakthrough | Log Breakthrough |
| ° C. | Volume | Volume | ° C. | Volume | Volume |
| 140 | 42520 | 4.629 | 140 | 39120 | 4.592 |
| 110 | 190800 | 5.281 | 110 | 128170 | 5.108 |
| 81 | 108200 | 6.034 | 81 | 516470 | 5.713 |
| 40* | 18,200,000 | 7.260 | 40* | 5,370,000 | 6.730 |

*Note that the breakthrough volumes at 40° C. are extrapolated from the calculated volumes at higher temperatures

Breakthrough volumes increase almost logarithmically with lower temperatures. Projected trendlines are shown as curves rather than straight lines. Straight-line extrapolation would give more conservative values considering only data from the current tests, however from past testing with 5A that included a fourth, lower-temperature point, fitting the calculation to a 2^{nd}—order polynomial provides a good empirical fit, so it is continued in use here.

In short, MS5A adsorbent is generally used in fluid purifiers for capturing water from gas streams due to its known high capacity for water. However, the inventors unexpectedly found that when used with nitrous oxide, MS3A had higher breakthrough volumes than MS5A and avoided the temperature spike upon initial charge.

Various aspects of different embodiments of the present disclosure are expressed in paragraphs X1 and X2 as follows:

X1. One embodiment of the present disclosure includes an inline fluid purifier including an elongated body including a first end, an opposing second end, and at least one side extending between the first end and the second end, the body including a central axis; a first endcap attached to the first end, the first endcap including an inline port arranged substantially parallel to the central axis; and a second endcap attached to the second end, the second endcap including an angled port arranged non-parallel to the central axis; wherein the body includes an interior defined by the at least one side, the first endcap, and the second endcap; wherein the interior includes adsorbent media.

Yet other embodiments include the features described in any of the previous paragraphs X1 or X2 as combined with one or more of the following aspects:

Wherein the angled port is arranged substantially perpendicular to the central axis.

Wherein the angled port is arranged perpendicular to the central axis.

Further including a first filter positioned between the inline port and the adsorbent media, the first filter including a pore diameter.

Further including a second filter positioned between the angled port and the adsorbent media, the second filter including a pore diameter.

Wherein the pore diameter of the second filter is greater than the pore diameter of the first filter.

Wherein the pore diameter of first filter and the pore diameter of the second filter are each within the range of 0.003 microns to 50 microns.

Wherein the pore diameter of the second filter is about 10 microns.

Wherein the pore diameter of the second filter is 10 microns.

Wherein the pore diameter of the first filter is about 1 micron.

Wherein the pore diameter of the first filter is 1 micron.

Wherein the adsorbent media include molecular sieves with a pore diameter of less than 3.3 angstroms.

Wherein the adsorbent media include molecular sieves with a pore diameter of less than 3.2 angstroms.

Wherein the adsorbent media include molecular sieves with a pore diameter of not more than 3 angstroms.

Wherein the adsorbent media include molecular sieves with a pore diameter of less than 3.3 angstroms and greater than 2.6 angstroms.

Wherein the adsorbent media include molecular sieves with a pore diameter of between 3.2 angstroms and 2.7 angstroms.

Wherein the adsorbent media include molecular sieves with a pore diameter of between 3.2 angstroms and 2.8 angstroms.

Wherein the adsorbent media include molecular sieves with a pore diameter of between 3.1 angstroms and 2.9 angstroms.

Wherein the adsorbent media include molecular sieves with a pore diameter of about 3 angstroms.

Wherein the adsorbent media include molecular sieves with a pore diameter of about 3.0 angstroms.

Wherein the adsorbent media include molecular sieves with a pore diameter of 3 angstroms.

Wherein the second endcap includes an internal chamber in fluid communication with an internal passageway of the angled port and an internal channel in fluid communication with the internal chamber and the interior of the body.

Wherein the internal passageway of the angled port extends at a non-parallel angle to the central axis, and wherein the internal channel extends substantially parallel to the central axis.

Wherein the internal passageway of the angled port extends substantially parallel to the central axis.

Wherein the internal passageway of the angled port extends parallel to the central axis.

Wherein the inline port includes an internal passageway extending substantially parallel to the central axis.

Wherein each of the inline port and angled port include a top portion including a diameter, a central portion including a diameter, and a bottom portion including a diameter, wherein the diameter of the central portion is larger than the diameters of the top portion or the bottom portion.

Wherein each of the inline port and angled port include an internal passageway extending between the top portion and the bottom portion.

Wherein the bottom portion of the inline port is received in a corresponding cavity in the first endcap and wherein the bottom portion of the angled port is received in a corresponding cavity in the second endcap.

Wherein the bottom portion of the inline port is received in and engaged by a corresponding cavity in the first endcap via a threaded engagement.

Wherein the bottom portion of the angled port is received in and engaged by a corresponding cavity in the second endcap via a threaded engagement.

Further including an assembly seal positioned between the inline port and the first endcap and an assembly seal positioned between the angled port and the second endcap.

Wherein each assembly seal includes a crush seal radially surrounding the bottom portion and abutting the central portion of the respective port, and an elastomeric seal radially surrounding the bottom portion of the respective port and abutting the crush seal.

Wherein the elastomeric seal fits within the cavity of the respective endcap and wherein the crush seal fits between the central portion of the respective port and the respective endcap.

Wherein the crush seal is a metal crush seal.

Wherein the crush seal and elastomeric seal of formed of different materials.

The foregoing detailed description is given primarily for clearness of understanding and no unnecessary limitations are to be understood therefrom, for modifications can be made by those skilled in the art upon reading this disclosure and may be made without departing from the spirit of the invention. Although specific spatial dimensions are stated herein, such specific quantities are presented as examples only. While the disclosed inline fluid purifier is discussed primarily in connection with purification of nitrous oxide gas, it should be understood that the inline fluid purifier is usable with other gases, liquids, and supercritical fluids.

What is claimed is:

1. An inline fluid purifier comprising:
a body including a first end, an opposing second end, and at least one side extending between the first end and the second end, the body including a central axis;
a first endcap attached to the first end, the first endcap including an inline port arranged substantially parallel to the central axis; and
a second endcap attached to the second end, the second endcap including an angled port arranged non-parallel to the central axis;
wherein the body includes an interior defined by the at least one side, the first endcap, and the second endcap;
wherein the interior includes adsorbent media.

2. The inline fluid purifier of claim 1, wherein the angled port is arranged substantially perpendicular to the central axis.

3. The inline fluid purifier of claim 1, further comprising
a first filter positioned between the inline port and the adsorbent media, the first filter including a pore diameter; and
a second filter positioned between the angled port and the adsorbent media, the second filter including a pore diameter.

4. The inline fluid purifier of claim 3, wherein the pore diameter of the second filter is greater than the pore diameter of the first filter.

5. The inline fluid purifier of claim 3, wherein the pore diameter of first filter and the pore diameter of the second filter are each within the range of 0.003 microns to 50 microns.

6. The inline fluid purifier of claim 1, wherein the adsorbent media include molecular sieves with a pore diameter of less than 3.3 angstroms.

7. The inline fluid purifier of claim 1, wherein the adsorbent media include molecular sieves with a pore diameter of less than 3.3 angstroms and greater than 2.6 angstroms.

8. The inline fluid purifier of claim 1, wherein the second endcap includes an internal chamber in fluid communication with an internal passageway of the angled port and an internal channel in fluid communication with the internal chamber and the interior of the body.

9. The inline fluid purifier of claim 8, wherein the internal passageway of the angled port extends at a non-parallel angle to the central axis, and wherein the internal channel extends substantially parallel to the central axis.

10. The inline fluid purifier of claim 9, wherein the internal passageway of the angled port extends substantially parallel to the central axis.

11. The inline fluid purifier of claim 1, wherein the inline port includes an internal passageway extending substantially parallel to the central axis.

12. The inline fluid purifier of claim 1, further comprising an assembly seal positioned between the inline port and the first endcap and an assembly seal positioned between the angled port and the second endcap.

13. The inline fluid purifier of claim 1, wherein each of the inline port and angled port include a top portion including a diameter, a central portion including a diameter, and a bottom portion including a diameter, wherein the diameter of the central portion is larger than the diameters of the top portion or the bottom portion.

14. The inline fluid purifier of claim 13, wherein each of the inline port and angled port include an internal passageway extending between the top portion and the bottom portion.

15. The inline fluid purifier of claim 13, wherein the bottom portion of the inline port is received in a corresponding cavity in the first endcap and wherein the bottom portion of the angled port is received in a corresponding cavity in the second endcap.

16. The inline fluid purifier of claim 15, further comprising an assembly seal positioned between the inline port and the first endcap and an assembly seal positioned between the angled port and the second endcap.

17. The inline fluid purifier of claim 16, wherein each assembly seal includes
a crush seal radially surrounding the bottom portion and abutting the central portion of the respective port, and
an elastomeric seal radially surrounding the bottom portion of the respective port and abutting the crush seal.

18. The inline fluid purifier of claim 17, wherein the elastomeric seal fits within the cavity of the respective endcap and wherein the crush seal fits between the central portion of the respective port and the respective endcap.

19. The inline fluid purifier of claim 17, wherein the crush seal is a metal crush seal.
